(19) United States
(12) Patent Application Publication
(10) Pub. No.: US 2006/0002732 A1
(43) Pub. Date: Jan. 5, 2006

(54) Liquid-type laser printer for eliminating internal gas by using sub-power and method thereof

(75) Inventors: Jong-in Hwang, Cheolwon-gun (KR); Kwoang-joe Seorl, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/124,255

(22) Filed: May 9, 2005

(30) Foreign Application Priority Data
Jul. 2, 2004 (KR) 10-2004-0051364

(51) Int. Cl. G03G 15/00

(52) U.S. Cl. 399/88; 399/92; 399/93

(57) ABSTRACT

A liquid-type laser printer for printing an image by using a liquid toner and including a gas eliminating unit for eliminating internal gas of the liquid-type laser printer, a main power unit for supplying a main power, a sub-power unit for supplying a sub-power, a drive signal generating unit driven by the main power unit or the sub-power unit for generating a drive signal for the gas eliminating unit, and a switching unit for applying the sub-power supplied from the sub-power unit to the drive signal generating unit if the main power unit is shut off. Therefore, although the main power or the main power unit may be shut off, the internal gas of the printer can be eliminated completely and stably.

### CROSS-REFERENCE TO RELATED APPLICATIONS

This application claims the benefit under 35 U.S.C. §119(a) of Korean Patent Application No. 10-2004-0051364, filed in the Korean Intellectual Property Office on Jul. 2, 2004, the entire disclosure of which is hereby incorporated by reference.

### BACKGROUND OF THE INVENTION

1. Field of the Invention

The present invention relates in general to a liquid-type laser printer for eliminating internal gas (that is, vapor carrier) and a method thereof. More particularly, the present invention relates to a liquid-type laser printer with a gas eliminating unit that is powered by a sub-power unit when a main power unit is shut off, and a method thereof.

2. Description of the Related Art

Technical advances in electronics have brought a rapid increase in the development of all kinds of peripherals to maximize the utility of a computer. One such peripheral device is a printer. A printer is a device for printing a document prepared by a computer onto a printing paper. In recent years, laser printers using lasers for printing a document have been developed and are now available at low prices.

Printing a document with a laser printer involves a series of processes comprised of cleaning, conditioning, writing, developing, transferring, and fusing. Laser printers are categorized into dry-type laser printers and liquid-type laser printers depending on which kind of toner (such as dry toner and liquid toner) is used for the developing process. Particularly, the liquid-type laser printer uses a liquid toner that contains liquid carrier materials comprised of hydrocarbon compounds from the alkane group, such as C₁₀H₂₂, C₁₁H₂₄, C₁₂H₂₆ and C₁₃H₂₈, and pigments.

Most of the liquid carrier materials contained in the liquid toner are recovered during the developing and transferring processes, but part of the materials remain on the paper when a fusing unit fuses an image onto the paper. The residual liquid carrier on the image usually turns into inflammable hydrocarbon gas (for example, methane gas (CH₄)) by a high heat generated from the fusing process. This inflammable hydrocarbon gas, or vapor carrier, is one of any VOC (Volatile Organic Compounds) that not only contaminates the surrounding environment when exposed outside the printer, but also generates offensive odors. Therefore, it is preferable to eliminate the vapor (or gas) before it is exhausted outside the printer.

FIG. 1 is a schematic diagram of a vapor carrier (hereinafter referred to as ‘gas’) elimination unit for use in a conventional liquid-type laser printer. Referring to FIG. 1, the gas produced from a fusing unit 10 is sucked into a gas eliminating unit 20 and disappears. To achieve this, the gas eliminating unit 20 includes a suction fan and an exhaust fan. The gas sucked through the suction fan can be removed by using one of filtration, thermal oxidation, and catalytic thermal oxidation methods. According to the filtration method, the gas is physically filtered and removed. According to the thermal oxidation method, the gas is oxidized thermally at a temperature higher than the ignition temperature of the gas (such as 600° C. to 800° C.). According to the catalytic thermal oxidation method, the gas is catalytically oxidized at a temperature (such as 150° C. to 400° C.) that is relatively lower than that of the thermal oxidation method and as a result, the gas is oxidized or thermally decomposed.

The gas eliminating unit 20 is normally powered by a main power source of the liquid-type laser printer in order to drive the suction fan and the exhaust fan for conversion treatment of the gas. Therefore, if a user turns off the power switch or if the printer is not plugged in, or if the main power is suddenly shut off because of a power blackout for example, gas suction is not properly performed and thus, the gas elimination process stops. As such, the gas not yet eliminated remains inside the fusing unit and is subsequently released outside the printer. Anyone, including the user, can then inhale the undesirable gas resulting in possible hazards to the user.

Also, when the gas undergoes the conversion treatment based on the catalytic thermal oxidation method, a heater is usually used to heat the gas to a temperature where the oxidation reaction state is highest. The heated gas is then cooled by a cooling fan and exhausted to the outside of the printer. If the cooling fan stops operating because of a power cutoff, the heat from the heater and the heat of the reaction between the catalyst and the gas, can then both be transferred directly to the gas eliminating unit 20 and the printer enclosure. In a worst case, the printer enclosure can be deformed and can even result in a printer fire.

Accordingly, a need exists for a system and method of safely and effectively maintaining a gas eliminating operation when main power is lost.

### SUMMARY OF THE INVENTION

It is, therefore, an object of the present invention to provide a liquid-type laser printer with a gas eliminating unit that can be powered by a sub-power unit when a main power unit is shut off, and a method thereof.

To achieve the above objects and advantages, a liquid-type laser printer is provided for printing an image by using a liquid toner, in which, the printer comprises a gas eliminating unit for eliminating internal gas of the liquid-type laser printer, a main power unit for supplying a main power, a sub-power unit for supplying a sub-power, a drive signal generating unit driven by the main power unit or the sub-power unit for generating a drive signal for the gas eliminating unit, and a switching unit for applying the sub-power supplied from the sub-power unit to the drive signal generating unit if the main power unit is shut off.

Preferably, the liquid-type laser printer further comprises a timer unit for sensing a point when the main power unit is shut off, counting the amount of time lapsed since the main power shut-off and if the time lapsed exceeds a predetermined time period, controlling the switching unit to shut off the sub-power supply. Therefore, by setting the gas eliminating unit to operate for only a predetermined time period after the main power is shut-off, unnecessary waste of the sub-power can be prevented.

More preferably, the main power unit and the sub-power unit are coupled to each other through a diode for preventing the backflow of current. Therefore, the sub-power unit can be charged by the main power supplied from the main power unit.

Preferably, the gas eliminating unit comprises a suction fan for sucking the internal gas, a heater for heating the internal gas being sucked to a predetermined temperature, a catalyst unit for reacting with the hot gas and thereby decomposing the gas into water and carbon dioxide, and a cooling fan for cooling and exhausting the carbon dioxide to the outside of the printer. Preferably, the internal gas is eliminated by using a catalytic thermal oxidation method.

Another aspect of the present invention is to provide a method of eliminating the internal gas of a liquid-type laser printer, wherein the printer is provided for printing an image by using a liquid toner. The method comprises the steps of eliminating the internal gas of the liquid-type laser printer while a main power is applied, supplying a sub-power as a replacement for the main power if the main power is shut off to thereby continue eliminating the internal gas of the liquid-type laser printer, counting the amount of time lapsed since the main is power shut-off, and shutting off the sub-power supply if the time lapsed exceeds a predetermined time period.

Preferably, the gas eliminating step comprises the sub-steps of sucking the internal gas, heating the gas being sucked to a predetermined temperature, reacting the hot gas with a designated catalyst and thereby decomposing the gas into water and carbon dioxide, and cooling and exhausting the carbon dioxide to the outside of the printer.

### BRIEF DESCRIPTION OF THE DRAWINGS

The above aspects and features of the present invention will become more apparent by describing certain embodiments of the present invention with reference to the accompanying drawings, in which:

FIG. 1 is a schematic diagram of a gas elimination unit for use in a conventional liquid-type laser printer;

FIG. 2 is a schematic block diagram illustrating a liquid-type laser printer according to an embodiment of the present invention;

FIG. 3 is a schematic block diagram illustrating a gas eliminating unit based on a catalytic thermal oxidation method;

FIG. 4 is a circuit diagram illustrating in greater detail an exemplary structure of the liquid-type laser printer of FIG. 2; and

FIG. 5 is a flow chart describing a method of eliminating the internal gas of a liquid-type laser printer according to an embodiment of the present invention.

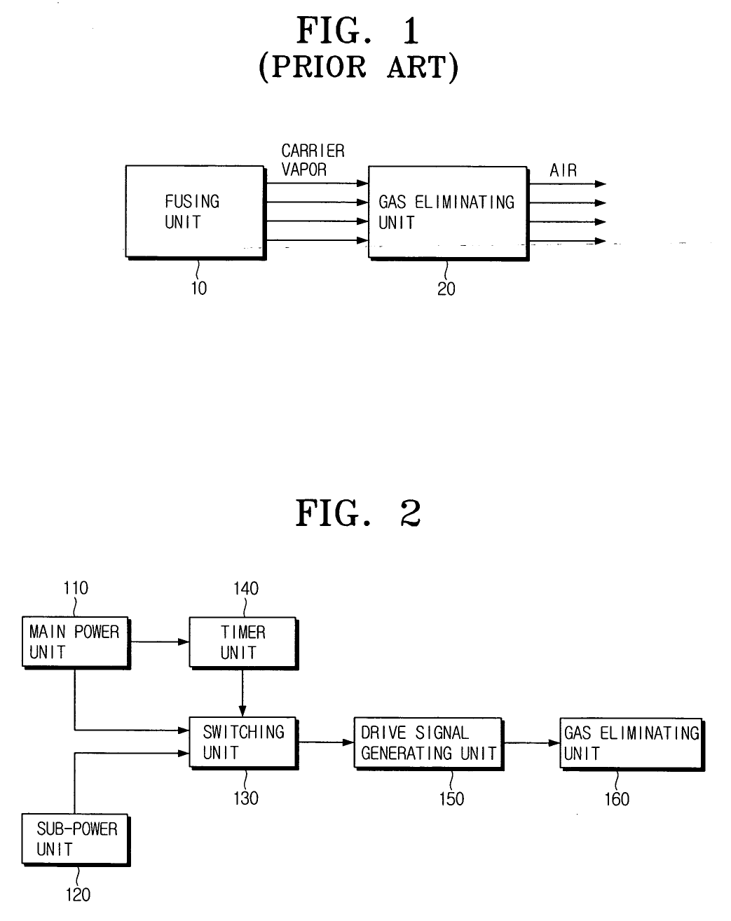

Throughout the drawings, like reference numerals will be understood to refer to like parts, components and structures.

### DETAILED DESCRIPTION OF EXEMPLARY EMBODIMENTS

Exemplary embodiments of the present invention will now be described in greater detail with reference to the annexed drawings. In the following description, a detailed description of known functions and configurations incorporated herein have been omitted for conciseness and clarity.

FIG. 2 is a schematic block diagram illustrating a liquid-type laser printer according to an embodiment of the present invention. Referring to FIG. 2, the liquid-type laser printer comprises a main power unit 110, a sub-power unit 120, a switching unit 130, a timer unit 140, a drive signal generating unit 150, and a gas eliminating unit 160.

The main power unit 110 is a source for supplying a main power, and can be comprised of any suitable device, such as a Switching Mode Power Supply (SMPS). The drive signal generating unit 150 is powered by the main power unit 110, and generates a drive signal for driving the gas eliminating unit 160. Once the gas eliminating unit 160 starts driving, it readily eliminates gas (that is, vapor carrier) produced from a fusing unit (not shown). As described above, the gas elimination unit 160 eliminates the gas by using one of filtration, thermal oxidation, and catalytic thermal oxidation methods.

FIG. 3 is a schematic block diagram illustrating a gas eliminating unit 160 based on a catalytic thermal oxidation method. Referring to FIG. 3, the gas eliminating unit 160 comprises a suction fan 161, a heater 162, a catalyst unit 163, and a cooling fan 164. The suction fan 161 sucks the gas produced from the fusing unit into the gas eliminating unit 160. The heater 162 then heats the gas being sucked into the gas eliminating unit 160 to an optimal temperature where the gas can react best or most effectively with a catalyst.

The catalyst unit 163 comprises a substrate and a catalyst coated on the outer surface of the substrate. Here, the substrate is comprised of gamma alumina and diatomaceous earth. Examples of the catalyst include Pd, Pt, Co₃O₄, PdO, Cr₂O₃, Mn₂O₃, CuO, SeO₂, FeO₂, Fe₂O₃, V₂O₅, NiO, Ag, MoO₃, and TiO₂. The gas is catalytically oxidized by the catalyst unit 163 and is decomposed into water and carbon dioxide.

Since the resulting carbon dioxide is in the form of hot air, being heated by the heater 162 and the heat from the reaction between the gas and the catalyst, the cooling fan 164 cools and exhausts the hot air to the outside of the printer. The components of the gas eliminating unit 160, that is, the suction fan 161, the heater 162, and the cooling fan 164, are powered by the main power unit 110.

Returning to FIG. 2, the sub-power unit 120 is used as a subsidiary power supply source. The switching unit 130 ensures that the drive signal generating unit 150 is powered by the main power unit 110 in a normal mode. However, if the main power or main power unit 110 is shut off, the switching unit 130 applies power from the sub-power unit 120 to the drive signal generating unit 150. In this way, the drive signal generating unit 150 is able to generate a drive signal even when the main power or main power unit 110 is shut off, and prevents the gas eliminating unit 160 from being stopped abruptly.

The timer unit 140 then senses whether the main power or main power unit 110 has been shut off. If the main power or main power unit 110 is shut off, the timer unit 140 counts the amount of time that has lapsed since the power cutoff. When the amount of time exceeds a predetermined time period, the timer unit 140 controls the switching unit 130 to stop the power supply from the sub-power unit 120. That is, by setting the gas eliminating unit 160 to automatically stop its operation when the predetermined time period is lapsed, unnecessary waste of the sub-power can be prevented.

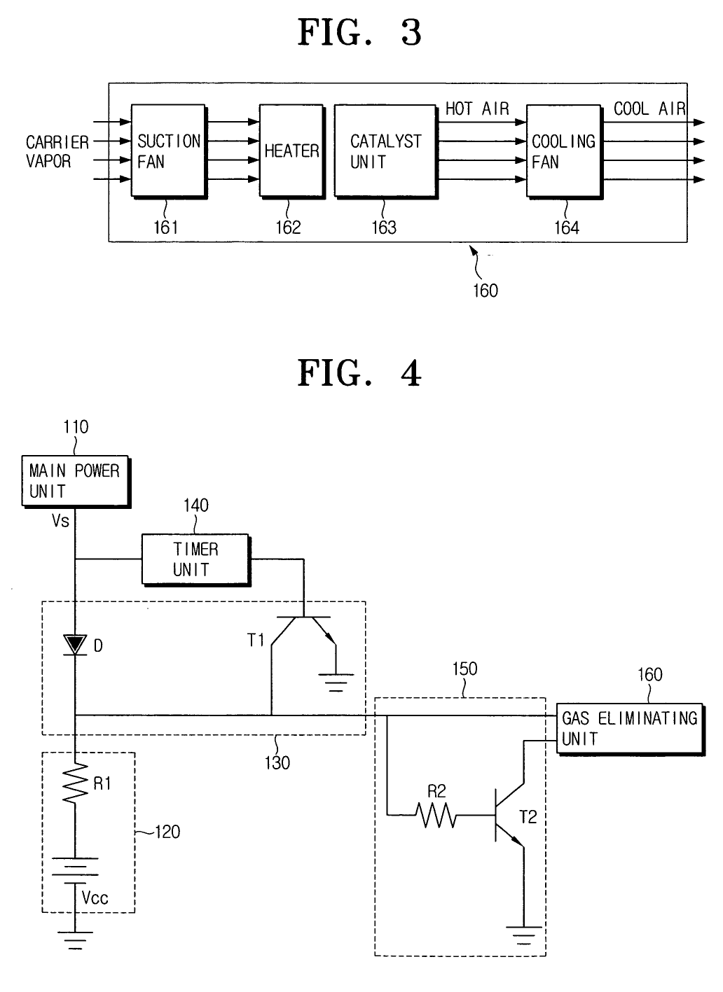

FIG. 4 is a circuit diagram for illustrating in greater detail a structure of the liquid-type laser printer of FIG. 2. Referring to FIG. 4, the sub-power unit 120 includes a rechargeable battery for supplying power of a certain voltage (Vcc), and a pull-up resistance R1 for pulling up the battery power.

The switching unit 130 preferably includes a diode D for connecting the main power unit 110 and the sub-power unit 120, and a transistor switch T1 that is controlled by the timer unit 140. The diode D prevents the backflow of an electric signal from the sub-power unit 120 to the main power unit 110. Under this architecture, the main power unit 110 supplies the main power Vs which in turn, charges the sub-power unit 120. Although the switching unit 130 of FIG. 4 is shown comprising a small number of elements, other components and features known to those skilled in the art can be added, such as a power stabilizing circuit to stabilize the power supply (Vs or Vcc) from the main power unit 110 or the sub-power unit 120. The power stabilizing circuit can be comprised of, for example, a combination of a capacitor and a resistor (not shown).

The main power Vs supplied from the main power unit 110 is applied to the drive signal generating unit 150. The drive signal generating unit 150 includes a transistor T2 and a base resistance R2. As such, if the main power Vs is applied, the transistor T2 is turned on and one terminal of the gas eliminating unit 160 is grounded. Further, the main power Vs is applied to the other terminal of the gas eliminating unit 160. As a result, a driving power with a voltage of Vs is applied to the terminals of the gas eliminating unit 160, thereby driving the suction fan 161, the heater 162, and the cooling fan 164, to eliminate the internal gas.

If the main power Vs is shut off, the gas eliminating unit 160 is then powered by the sub-power unit 120. The sub-power Vcc from the sub-power unit 120 is provided to the gas eliminating unit 160 via the switching unit 130. If the sub-power Vcc is applied, the transistor T2 is turned on and one terminal of the gas eliminating unit 160 is grounded. Further, the sub-power Vcc is applied straight to the other terminal of the gas eliminating unit 160. As a result, a driving power with a voltage of Vcc is applied to the terminals of the gas eliminating unit 160, thereby driving the suction fan 161, the heater 162, and the cooling fan 164, to eliminate the internal gas.

The timer unit 140 then senses whether the main power Vs from the main power unit 110 has been shut off. To achieve this, the timer unit 140 has a pull-up resistance (not shown) connected to the output terminal of the main power unit 110. If a signal applied through the pull-up resistance falls to a low level, the timer unit 140 determines that the main power Vs has been shut off.

The timer unit 140 then counts the amount of time that has lapsed since the main power Vs was shut off. If the amount of time exceeds a predetermined time period, a control signal is applied to the transistor switch T1 in the switching unit 130. When the transistor switch T1 is on, both terminals of the gas eliminating unit 160 are grounded to earth and thus, the sub-power Vcc is shut off. The function of the timer unit 140 therefor contributes substantially to power savings.

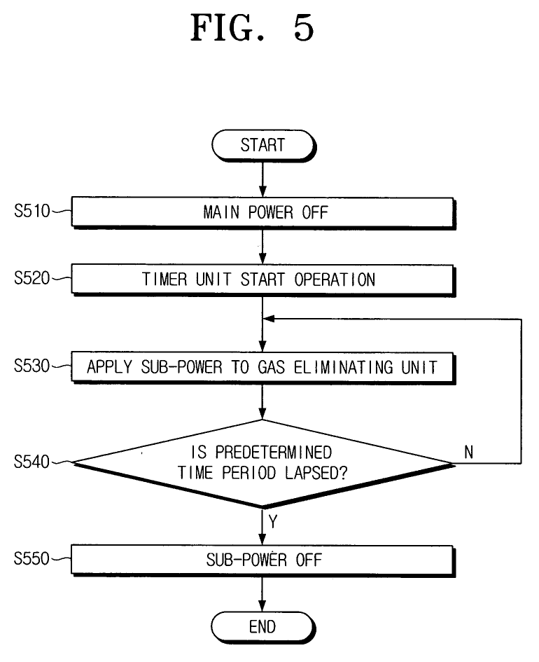

FIG. 5 is a flow chart describing a method of eliminating internal gas of the liquid-type laser printer according to an embodiment of the present invention. Referring to FIG. 5, if it is sensed that the main power Vs is shut off at step (S510), the timer unit 140 counts the amount of time that has lapsed since the main power Vs was shut off at step (S520).

If the main power Vs is shut off, the sub-power Vcc is applied as a replacement for the main power Vs to keep driving the gas eliminating unit 160 at step (S530). As described above, the gas eliminating unit 160 can eliminate internal gas by using any number of methods, such as the catalytic thermal oxidation method. In this case, the internal gas is first sucked into the gas eliminating unit 160 and heated to a designated temperature where the gas reacts best with the catalyst. When the reaction between the gas and the catalyst is completed, water and carbon dioxide are produced. The carbon dioxide is then cooled and exhausted to the outside of the printer.

The timer unit 140 then decides whether the amount of time lapsed exceeds the predetermined time period at step (S540), and if so, the sub-power Vcc is shut off at step (S550). In this manner, the gas eliminating unit 160 can be more effectively used for eliminating the internal gas.

According to exemplary embodiments of the present invention, in cases where the main power may be shut off because of a blackout or switch off, the sub-power unit supplies the driving power to the gas eliminating unit in the liquid-type laser unit. Thus, the undesired internal gas can be eliminated completely and stably, even after the main power (or the main power unit) is shut-off. Moreover, by setting the gas eliminating unit to operate for only the predetermined period of time after the main power shut-off, unnecessary waste of power by the sub-power unit can be prevented.

The foregoing embodiments and advantages are merely exemplary, and are not to be construed as limiting the present invention. The present teachings can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A liquid-type laser printer for printing an image by using a liquid toner, the printer comprising:
a gas eliminating unit for eliminating internal gas of the liquid-type laser printer;
a main power unit for supplying a main power to the gas eliminating unit;
a sub-power unit for supplying a sub-power to the gas eliminating unit;
a drive signal generating unit driven by the main power unit or the sub-power unit for generating a drive signal for the gas eliminating unit; and
a switching unit for applying the sub-power supplied from the sub-power unit to the drive signal generating unit if the main power unit is shut off.

2. The liquid-type laser printer according to claim 1, further comprising:
a timer unit for sensing a point when the main power unit is shut off,
counting the amount of time lapsed since the main power shut-off, and
controlling the switching unit to shut off the sub-power supply if the time lapsed exceeds a predetermined time period.

3. The liquid-type laser printer according to claim 1, wherein the sub-power unit is charged by the main power supplied from the main power unit.

4. The liquid-type laser printer according to claim 3, wherein the switching unit comprises a diode for electrically coupling the sub-power unit and the main power unit.

5. The liquid-type laser printer according to claim 4, wherein the sub-power unit comprises a rechargeable battery that is configured to be charged by the main power supplied from the main power unit via the diode.

6. The liquid-type laser printer according to claim 2, wherein the switching unit comprises a first transistor electrically coupled with the timer for shutting off the sub-power supply.

7. The liquid-type laser printer according to claim 1, wherein the gas eliminating unit comprises:
a suction fan for sucking the internal gas;
a heater for heating the internal gas being sucked to a predetermined temperature;
a catalyst unit for reacting with the hot gas and thereby decomposing the gas into water and carbon dioxide; and
a cooling fan for cooling and exhausting the carbon dioxide.

8. A method of eliminating internal gas of a liquid-type laser printer, the method comprising the steps of:
eliminating the internal gas of the liquid-type laser printer while a main power is applied;
supplying a sub-power as a replacement for the main power if the main power is shut off to thereby continue eliminating the internal gas of the liquid-type laser printer;
counting the amount of time lapsed since the main power shut-off; and
shutting off the sub-power supply if the time lapsed exceeds a predetermined time period.

9. The method according to claim 8, wherein the gas eliminating step further comprises the sub-steps of:
sucking the internal gas;
heating the internal gas being sucked to a predetermined temperature;
reacting the hot gas with a designated catalyst and thereby decomposing the gas into water and carbon dioxide; and
cooling and exhausting the carbon dioxide.
